(19) United States
(12) Patent Application Publication
(10) Pub. No.: US 2008/0190906 A1
(43) Pub. Date: Aug. 14, 2008

(54) Electrical current source, in particular welding current source

(75) Inventor: Hubert Aigner, Taufkirchen (AT)

Correspondence Address: Lipsitz & McAllister, LLC, 755 MAIN STREET, MONROE, CT, 06468, US

(73) Assignee: Lorch Schweisstechnik GmbH, Auenwald (DE)

(21) Appl. No.: 12/011,994

(22) Filed: Jan. 29, 2008

Related U.S. Application Data
(63) Continuation of application No. PCT/EP2006/064846, filed on Jul. 31, 2006.

(30) Foreign Application Priority Data
Aug. 2, 2005 (DE) 10 2005 036806.9

(51) Int. Cl. B23K 9/10

(52) U.S. Cl. 219/130.21

(57) ABSTRACT

According to the invention, parallel resonant converters which are or can be connected to a load circuit via a transformer in each case are provided with a common series circuit of the secondary sides of the transformers. Therefore, despite variation of the frequency-determining components, it is possible for all the resonant converters to supply an output-side load circuit with approximately identical powers when the bridge circuits of the resonant converters are clocked in a synchronous manner.

This application is a continuation of international application number PCT/EP2006/064846 filed on Jul. 31, 2006.

The present disclosure relates to the subject matter disclosed in international application number PCT/EP2006/064846 of Jul. 31, 2006 and German application number 10 2005 036 806.9 of Aug. 2, 2005, which are incorporated herein by reference in their entirety and for all purposes.

### BACKGROUND OF THE INVENTION

The invention relates to an electrical current source, in particular a welding current source, having the features of the preamble of Patent Claim 1.

EP 1 251 991 B1 describes a welding current source with a resonant converter which has a bridge circuit which at the input end is connected to a direct-current source. The bridge circuit is in the form of a full bridge. At the output end, the bridge circuit is connected to a resonant circuit whose outputs are connected directly to the load circuit.

A further current source with a resonant converter and a bridge circuit in the form of a half-bridge and without a transformer is disclosed in DE 44 11 227 A1.

It is known, in principle, to connect converters in parallel when a high power is required in the load circuit. This is readily possible when so-called forward-biased or blocking converters are used because these converters permit clock-synchronous pulse width modulation without resulting in an appreciable uneven distribution of power between the converters. The power transmitted by each converter is dependent virtually only on the respective pulse width of the pulse width modulation.

By contrast, in the case of resonant converters, the transmitted power is highly dependent on the dimensions of the components of the resonant circuit. Therefore, when resonant converters are connected in parallel, very diverse transmission of power by the converters which are connected in parallel has to be expected if all the parallel converters are modulated in the same way, on account of the unavoidable variation of the components. This is therefore equivalent to a situation where, without special measures, uniform distribution of power to a plurality of parallel resonant converters can be achieved only with individual control of the parallel converters. This is equivalent to an undesirably high degree of outlay on control. In addition, a separate output-end rectifier at the input end of the load circuit has to be associated with each resonant converter in order to prevent alternating-current losses.

JP 10216936 discloses an electrical welding current source in which two resonant converters are connected in parallel. Each resonant converter has a bridge circuit which is connected at the input end to an electrical direct-current source and a resonant circuit which is disposed at the output end of the bridge circuit and has a transformer. The secondary side of the transformer is connected to an output-end load circuit. The secondary sides of the transformers of the resonant circuits are electrically connected in series with one another.

It is an object of the invention to firstly permit high powers in the load circuit and secondly to keep the required outlay on circuitry and control extremely low in a current source of the type specified in the introduction.

### SUMMARY OF THE INVENTION

According to the invention, this object is achieved by an electrical current source having the features of Patent Claim 1.

The invention is based on the general idea of providing a secondary side of the transformers which is common to the parallel resonant converters, so that the parallel resonant circuits are “fixedly” coupled to one another and the parallel resonant converters are virtually synchronized in respect of their resonant oscillations. To this end, the resonant converters, on the secondary side of the transformers, have an associated common parallel capacitance, so that the resonant converters operate in parallel as parallel resonant converters or as series-parallel resonant converters. The common parallel capacitance has a frequency-determining effect on all the resonant converters, so that the resonant oscillations of the converters are particularly highly synchronized.

It is therefore readily possible to clock the bridge circuits of the resonant converters which are connected in parallel in a completely synchronous manner, with the result that, even for a very large number of parallel resonant converters, only the same amount of outlay on control is required as for a single resonant converter.

Furthermore, a single rectifier can be provided for the parallel resonant converters on the secondary side of the transformers.

According to a preferred embodiment, the series circuit of the secondary sides of the transformers can be formed such that entire secondary sides are electrically connected in series in each case.

Instead of this, it is also possible, according to a further preferred embodiment of the invention, to provide secondary-side center taps on the said transformers and to form the series circuit such that in each case a secondary-side portion of the transformer of a resonant converter is electrically connected directly in series with a secondary-side portion of the transformer of another resonant converter.

With regard to preferred features of the invention, reference is moreover made to the claims and the following explanation of the drawing, on the basis of which particularly preferred embodiments of the invention are described in greater detail.

Protection is claimed not only for the expressly described or specified combinations of features but, in principle, also for any desired sub-combination of these features.

### BRIEF DESCRIPTION OF THE DRAWINGS

FIG. 1 shows a circuit diagram of a first embodiment of the invention with two parallel resonant converters which, at the input end, are connected in parallel with an electrical DC voltage source,

FIG. 2 shows an embodiment which is modified in comparison with FIG. 1 and in which the parallel resonant converters are connected, at the input end, in series with the direct electrical current source,

FIG. 3 shows an arrangement which corresponds to FIG. 1 and has more than two parallel resonant converters,

FIG. 4 shows an embodiment in which the secondary sides of the output-end transformers of the resonant converters have center taps,

FIG. 5 shows a modification of the circuit which is illustrated in FIG. 4,

FIG. 6 shows a first variant with a half-bridge circuit,

FIG. 7 shows a further variant with a half-bridge circuit, and

FIG. 8 shows a modification of the embodiment according to FIG. 2.

### DETAILED DESCRIPTION OF THE INVENTION

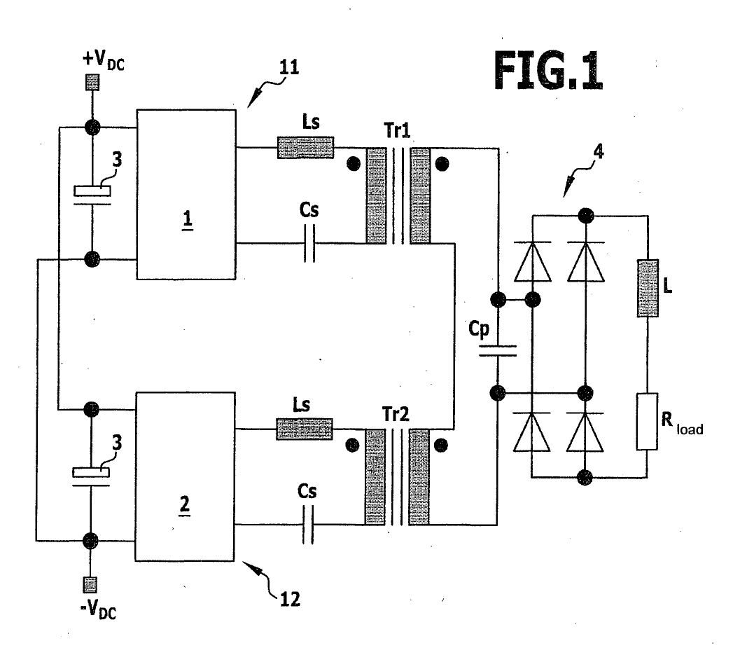

According to FIG. 1, two resonant converters 11 and 12 which are connected in parallel with one another are connected to the output contacts +V_{DC} and −V_{DC}. Each resonant converter 11 and 12 has, at the input end, a clocked bridge circuit 1 or 2 which converts the input-end direct electrical voltage of the direct-current source into an output-end alternating electrical voltage whose frequency corresponds to the clock frequency. In order to prevent alternating electrical currents or voltages from being able to be coupled back to the input end of the bridge circuits 1 and 2, the inputs of the two bridge circuits 1 and 2 are in each case connected to one another via capacitors 3 with a high capacitance, for example via electrolytic capacitors.

Series circuits which comprise an inductance Ls, the primary side of a high-frequency transformer Tr1 or Tr2 and a series capacitance Cs are in each case disposed between the outputs of the bridge circuits 1 and 2. The secondary sides of the transformers Tr1 and Tr2 are electrically connected to one another in series and are connected in parallel with a parallel capacitance Cp which is common to both resonant converters 11 and 12. The inductance Ls can also be formed by an integrated leakage inductance of the transformer Tr1 or Tr2.

A rectifier circuit 4 which is common to the two resonant converters 11 and 12 is disposed on the secondary side in relation to the transformers Tr1 and Tr2 and supplies an electrical load circuit, for example a welding process which is illustrated in FIG. 1 as an electrical equivalent circuit diagram, that is to say with a series circuit comprising an inductance L and load resistor R_{load}, is disposed in parallel with the parallel capacitance Cp.

On account of the series circuit of the secondary sides of the transformers Tr1 and Tr2, the resonant converters 11 and 12 are strongly coupled to one another and are synchronized with one another in terms of oscillation since the parallel resonant capacitor Cp acts on the individual resonant circuits at the input end of the transformers Tr1 and Tr2 via the secondary windings, which are connected in series, of the transformers Tr1 and Tr2.

Since, according to the invention, the parallel capacitance Cp is connected in parallel with the secondary sides, which are connected in series, of the transformers Tr1 and Tr2, said parallel capacitance is a determining component for the resonant frequency of both resonant converters 11 and 12. Despite unavoidable variation of the values of the inductances Ls and of the capacitances Cs, virtually identical and in-phase electrical currents or identical and in-phase electrical voltages occur between the outputs of the bridge circuits 1 and 2 if the bridge circuits 1 and 2 are clocked in a synchronous manner.

It is precisely this synchronous clocking of the bridge circuits 1 and 2 which is provided according to the invention and is desired in terms of low outlay on control for clocking. As a result, the resonant converters 11 and 12 therefore each contribute approximately half of the power which is supplied to the load circuit when the bridge circuits 1 and 2 of said resonant converters are clocked in a synchronous manner.

In the example of FIG. 1, the resonant converters 11 and 12 are each in the form of series-parallel resonant converters, each converter 11 or 12 having the capacitance Cs which is connected in series with its inductance Ls and also the parallel capacitance Cp which is common to both converters.

In a deviation from the illustration shown, the converters 11 and 12 could also be in the form of parallel resonant converters. In this case, the capacitances Cs are dispensed with.

The common parallel capacitance Cp can, in principle, be dispensed with if the series capacitance Cs is present and the resonant converters are accordingly in the form of series resonant converters. The secondary side on its own, which is common to the converters, of the transformers Tr1 and Tr2 ensures sufficiently synchronous oscillation of the converters when the bridge circuits 1 and 2 are clocked in a synchronous manner. The synchronization of the oscillations is additionally improved by the common parallel capacitance Cp.

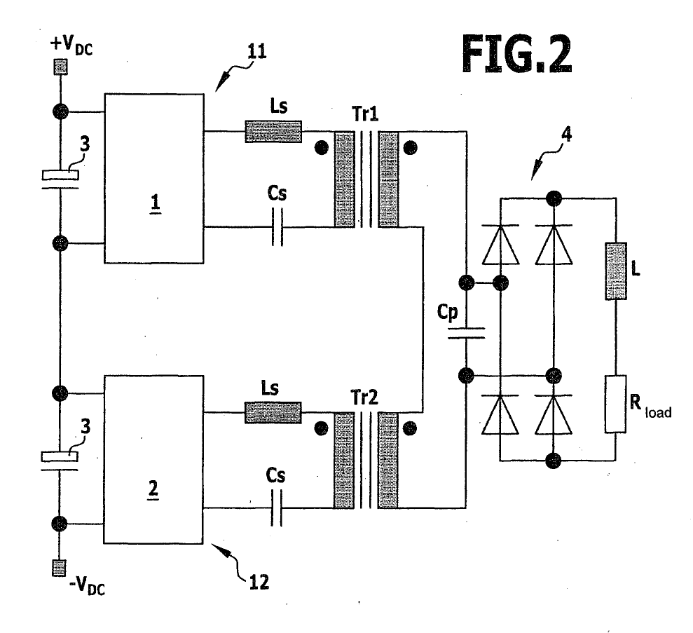

The arrangement of FIG. 2 differs from the arrangement according to FIG. 1 only in that the inputs of the bridge circuits 1 and 2 of the converters 11 and 12 are connected in series between the contacts +VDC and −VDC of the direct-current source. A circuit of this type is expedient if the electrical input voltage to the bridge circuits 1 and 2 is intended to be half the size of the electrical voltage between the contacts of the direct-current source.

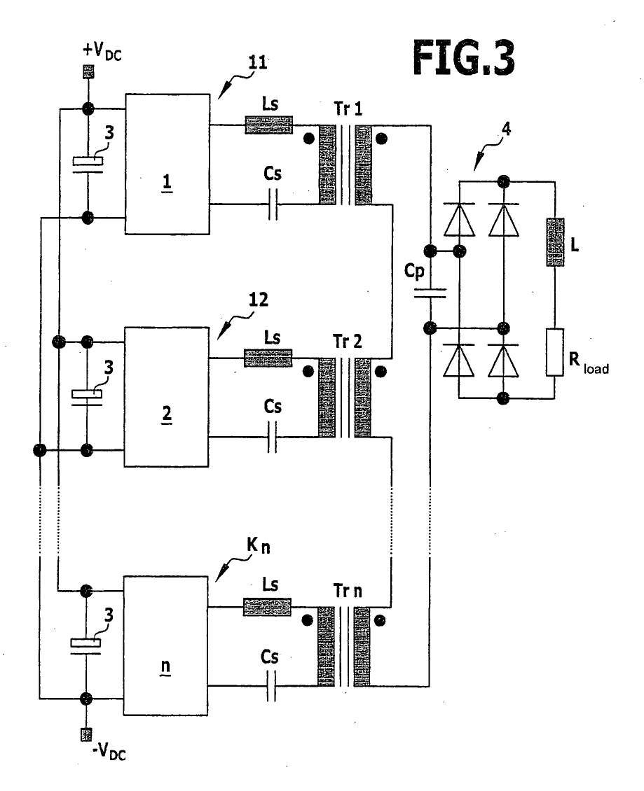

FIG. 3 then shows that more than two resonant converters 11 and 12 to Kₙ with a common secondary side of the transformers Tr1 to Trn and a common parallel capacitance Cp operate in parallel and can be connected to a common rectifier 4 at the input end of the load circuit L, R_{load}.

In this case, the associated bridge circuits 1 and 2 to n can, as is illustrated in FIG. 3, be connected in parallel at the input end, analogously to the arrangement in FIG. 1.

However, it is also possible, in principle, to provide an input-end series circuit according to FIG. 2.

The series capacitances Cs may possibly be dispensed with too.

If the series capacitances Cs are present, the common parallel capacitance Cp could, in principle, be dispensed with because the series circuit of the secondary sides of the transformers Tr1 to Trn effects on its own sufficient synchronization of the converters 11, 12 to Kₙ. However, the parallel capacitance is advantageous with regard to particularly good synchronization.

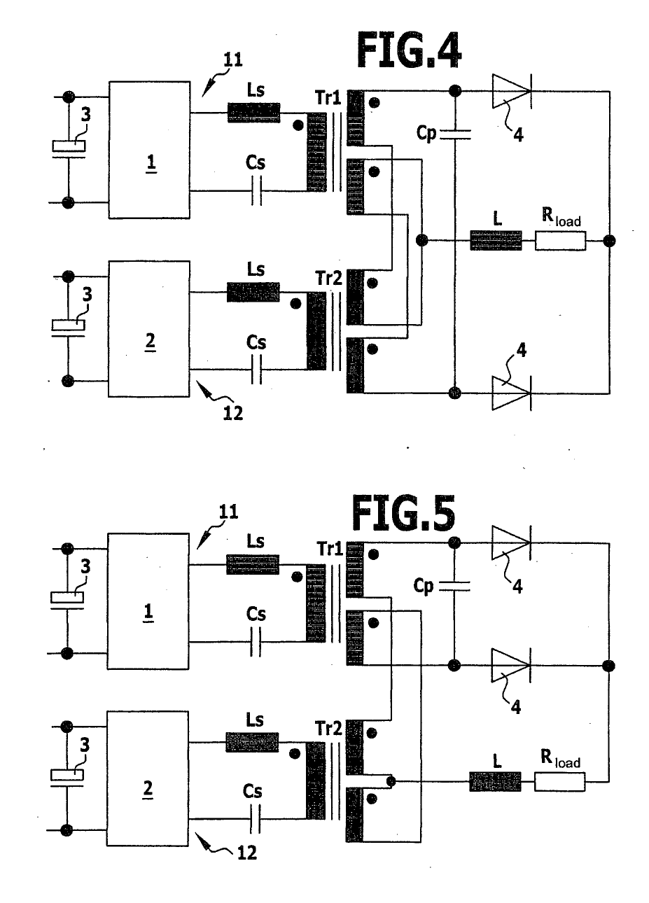

FIGS. 4 and 5 show, by way of example, two embodiments in which the secondary sides of the transformers Tr1 and Tr2 are provided with center taps. The secondary-side part-windings of the transformers Tr1 and Tr2 can accordingly be connected in series in a different way.

In FIGS. 1 to 5, it is assumed that the bridge circuits 1 and 2 to Kₙ are in the form of full bridges.

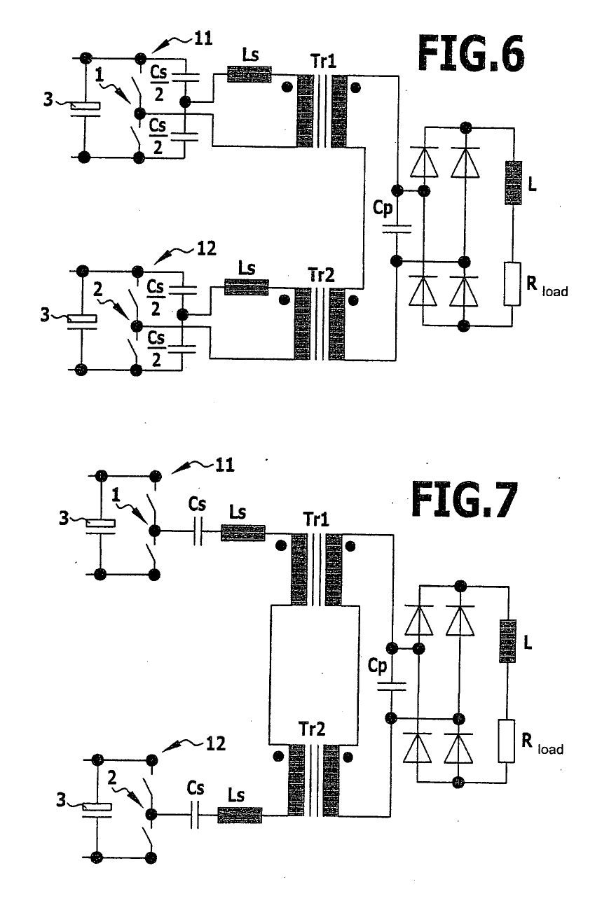

FIG. 6 then shows that the bridge circuits 1 and 2 can also be in the form of half-bridges, the series capacitance Cs being formed by two capacitors with the capacitances Cs/2.

The resonant converters 11 and 12 again form series-parallel converters in conjunction with the common parallel capacitance Cp which is connected in parallel with the secondary sides, which are connected in series, of the transformers Tr1 and Tr2.

The parallel capacitance Cp can optionally be dispensed with since the series circuit of the secondary sides of the transformers Tr1 and Tr2 ensures sufficient synchronization of the resonant converters 11 and 12 when the half-bridges 1 and 2 are clocked in a synchronous manner. However, the provision of the parallel capacitance Cp is extremely advantageous with regard to a particularly high degree of synchronization.

At the input end, the bridge circuits 1 and 2 can be connected in parallel or in series with an electrical DC voltage source in the same way as is illustrated by way of example in FIGS. 1 and 2.

A further possibility for connecting in parallel two resonant converters 11 and 12 having input-end half-bridge circuits 1 and 2 is shown in FIG. 7. Here, the primary sides, in addition to the secondary sides, of the transformers Tr1 and Tr2 are connected in series. In this way, the resonant converters 11 and 12 electrically form a single “large” resonant converter, the half bridges 1 and 2 together acting like a full bridge.

So that the resonant converters 11 and 12 of FIG. 7 can be used individually, independently of one another, switch-over or changeover arrangements have to be provided which permit the terminal, which is in each case connected to the parallel resonant converter in FIG. 7, of the primary side of the transformer Tr1 of the resonant converter 11 or of the transformer Tr2 of the resonant converter 12 to be connected between two capacitances which are connected in series between the inputs of the respective bridge circuit 1 or 2.

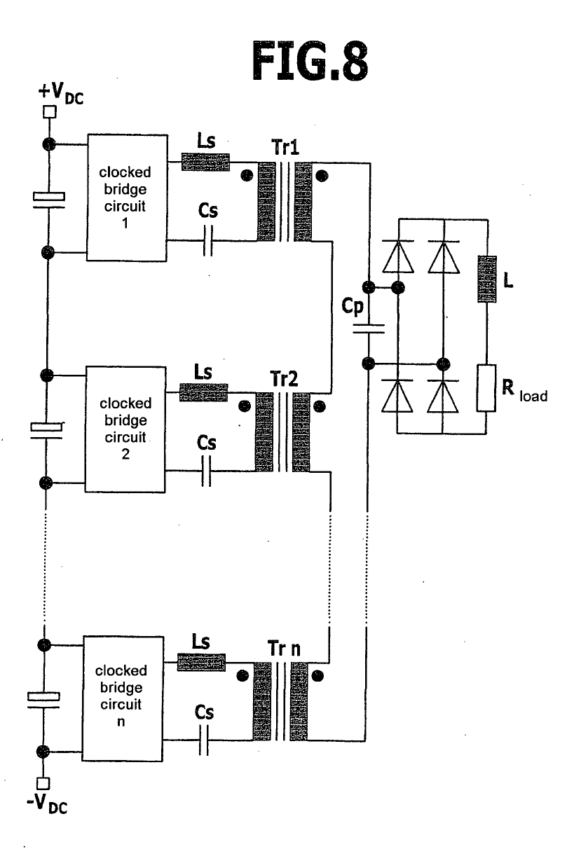

In contrast to FIG. 2 which illustrates a circuit with two modules or bridge circuits 1, 2, FIG. 8 shows a corresponding circuit with n modules/bridge circuits.

1. Electrical current source, in particular welding current source, with a resonant converter which has a clocked bridge circuit, which at the input end is connected or connectable to an electrical direct-current source, and a resonant circuit which is disposed at the output end of the bridge circuit and has a transformer, and is connected or connectable to an output-end load circuit, in particular a welding process, via the secondary side of the transformer, at least two resonant converters being provided which at the input end are connected or connectable in series or in parallel, the secondary sides of the respective transformers being electrically connected entirely or partially in series, and the resonant converters having a common parallel capacitance which is electrically connected in parallel with the secondary sides or secondary-side portions of the transformers which are connected in series.

2. Current source according to claim 1, wherein entire secondary sides of the transformers are connected in series in each case.

3. Current source according to claim 1, wherein the transformers have secondary-side center taps and in each case a secondary-side portion of each transformer is electrically connected directly in series with a secondary-side portion of the transformer of another resonant converter.

4. Current source according to claim 1, wherein a rectifier which is common to all the resonant converters is disposed at the input end of the load circuit.

5. Current source according to claim 1, wherein capacitors with a high capacitance are disposed between the inputs of the bridge circuits (1, 2, n).

6. Current source according to claim 1, wherein the bridge circuits are in the form of full bridges.

7. Current source according to claim 1, wherein the bridge circuits are in the form of half-bridges.

8. Current source according claim 1, wherein each resonant converter has its own series capacitance which is electrically connected in series to the primary side of the transformer of the respective resonant converter.
